(19) United States
(12) Patent Application Publication
(10) Pub. No.: US 2006/0185940 A1
(43) Pub. Date: Aug. 24, 2006

(54) Auxiliary handbrake operating device

(76) Inventor: Szu-Fang Tsai, Chang-Hua Hsien (TW)

Correspondence Address: LEONG C LEI, PMB # 1008, 1867 YGNACIO VALLEY ROAD, WALNUT CREEK, CA, 94598, US

(21) Appl. No.: 11/060,435

(22) Filed: Feb. 18, 2005

(51) Int. Cl. B62L 1/02

(52) U.S. Cl. 188/24.12

(57) ABSTRACT

An auxiliary handbrake operating device is positioned between the handbrake assembly mounted on the bicycle frame and the normal handbrake operating device along the brake wire. The brake wire goes directly through a wire hole on the auxiliary handbrake operating device so that the normal handbrake operating device at the end of the handle bar could pull the brake wire and, therefore, the brake arms of the handbrake assembly to brake the bicycle without any interference as usual. On the other hand, when the auxiliary handbrake operating device is gripped, it will push a cable wrap around the brake wire which in turn would force the handbrake assembly to brake the bicycle.

### BACKGROUND OF THE INVENTION

(a) Technical Field of the Invention

The present invention generally relates to bicycle handbrakes, and more specifically to an auxiliary handbrake operating device for operating the bicycle handbrakes.

(b) Description of the Prior Art

For road bikes, their handle bars are usually composed of a linear section and two curved sections extended from the two end of the linear section. The design allows a rider to maintain a more comfortable body position with the hands resting on the linear section. To speed up, the rider could keep the hands on the curved sections so that the body is closer to the bicycle frame and the air resistance is therefore lower. Conventionally, the handbrake operating devices are usually positioned on the curved sections. This however causes inconvenience and safety concern when riding with the hands on the linear section, as the rider has to reach for the handbrake operating device in order to brake the bicycle. Therefore recently there are bicycles equipped with independent handbrake operating devices both on the curved sections and the linear section so that the rider could quickly access the handbrake operating devices no matter where the hands are placed.

A conventional handbrake operating device mainly contains a positioning seat fixedly locked to the handle bar of the bicycle and a movable operating handle pin-joined to the positioning seat. A brake wire has an end with a wire head installed in a connection device of the operating handle and has another end inserted through a guiding tube of the positioning seat and connected to the handbrake assembly. When the operating handle is gripped, the brake wire and in turn the brake arms of the handbrake assembly are pulled to close in on the wheel rim so as to brake the bicycle. For these pull-type handbrake operating devices, the handbrake would have a better performance when a larger force is exerted on the operating handle within a very short period of time. In other words, the brake performance would vary depending on the rider's gripping force and how strong the rider is. Such user dependency leaves rooms for further improvement.

Accordingly, a push-type handbrake operating device is proposed, as disclosed in the Republic of China Patent No. 462,012. The push-type handbrake operating device has an L-shape joining section on the position seat. The operating handle is placed inside and pin-joined to the joining section. A brake wire inside a cable wrap has one of its ends connected to the joining section (instead of the operating handle) and has another end goes through the operating handle and a guiding bolt screwed on the operating handle. The cable wrap is between the guiding bolt and the handbrake assembly; so that, when a user pulls the operating handle, the guiding bolt forces the cable wrap to push the brake arms of the handbrake assembly so as to brake the bicycle.

The difference of the foregoing push-type and conventional pull-type handbrake operating devices is that the push-type handbrake operating devices push the cable wrap around the brake wire while the pull-type handbrake operating devices pull the brake wire only. Despite the better performance of the push-type handbrake operating devices, their design also requires them to be installed at the curved sections of the handle bar. As such, a rider still has to reach for them and suffers the same inconvenience and safety issue.

### SUMMARY OF THE INVENTION

The primary purpose of the present invention is to provide an auxiliary push-type handbrake operating device positioned between the handbrake assembly and the normal pull-type handbrake operating device along the brake wire. The brake wire goes directly through a wire hole on the auxiliary handbrake operating device so that the normal handbrake operating device at the end of the handle bar could pull the brake wire and, therefore, the brake arms of the handbrake assembly to brake the bicycle without any interference as usual. On the other hand, when the auxiliary handbrake operating device is gripped, it would push a cable wrap around the brake wire which in turn would force the handbrake assembly to brake the bicycle. The operation of the normal and auxiliary handbrake operating devices is independent from each other.

Moreover, the design of the present invention is straightforward and simple; the wire hole on the body of the auxiliary handbrake operating device could be easily formed with drilling.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective view showing auxiliary handbrake operating devices according to the present invention installed on a bicycle frame.

FIG. 2 is an explosion perspective view of an auxiliary handbrake operating device according to the present invention.

FIG. 3 is a perspective view showing an assembled auxiliary handbrake operating device according to the present invention.

FIG. 4 is a top sectional view of an auxiliary handbrake operating device according to the present invention under an inoperative condition.

FIG. 5 is a top sectional view of an auxiliary handbrake operating device according to the present invention under an operated condition.

FIG. 6 is a front view showing an auxiliary handbrake operating device according to the present invention installed on a bicycle frame.

FIGS. 7A and 7B is an enlarged view showing the operation of a handbrake assembly when triggered by an auxiliary handbrake operating device according to the present invention.

FIGS. 8A and 8B is an enlarged view showing the operation of a handbrake assembly when triggered by a normal handbrake operating device according to the present invention.

### DETAILED DESCRIPTION OF THE PREFERRED EMBODIMENTS

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

In the following, detailed description along with the accompanied drawings is given to better explain preferred embodiments of the present invention. Please note that some parts of the accompanied drawings are not drawn to scale or are somewhat exaggerated. It should be understood that this is for illustrative purpose and is not intended to limit the presentation in any way.

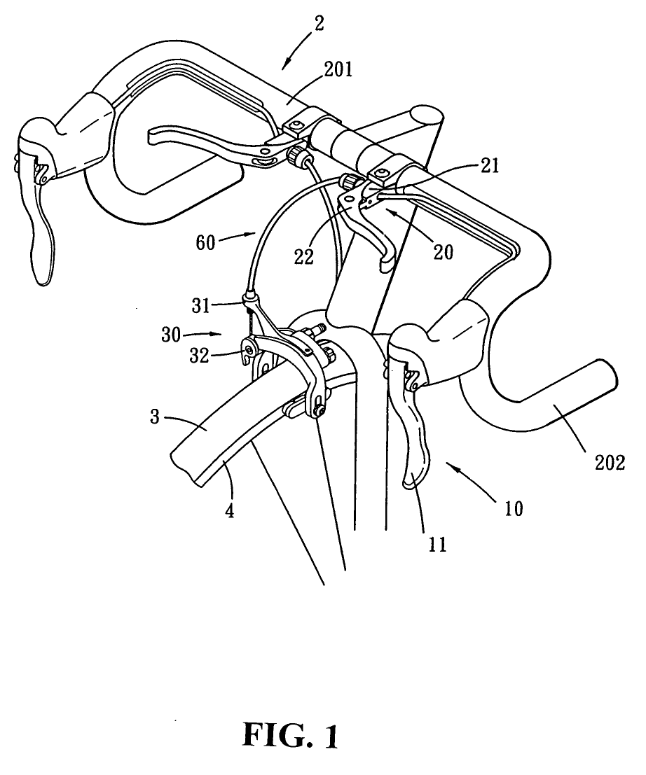

Please refer to FIG. 1. As illustrated, on the handle bar 2, there are normal handbrake operating devices 10 and auxiliary handbrake operating devices 20. The normal and auxiliary handbrake operating devices 10 and 20 independently control the handbrakes 30 mounted on the bicycle frame to brake the bicycle by gripping the rim 4 of the wheel 3.

The handle bar 2 has a linear section 201 and, extended from the ends of the linear section 201, curved sections 202. The normal handbrake operating devices 10 are installed on the curved sections while the auxiliary handbrake operating devices 20, which are the subject of the present invention, are installed on the linear section 201. The normal handbrake operating devices 10 are not the subject of the present invention and their description is therefore omitted.

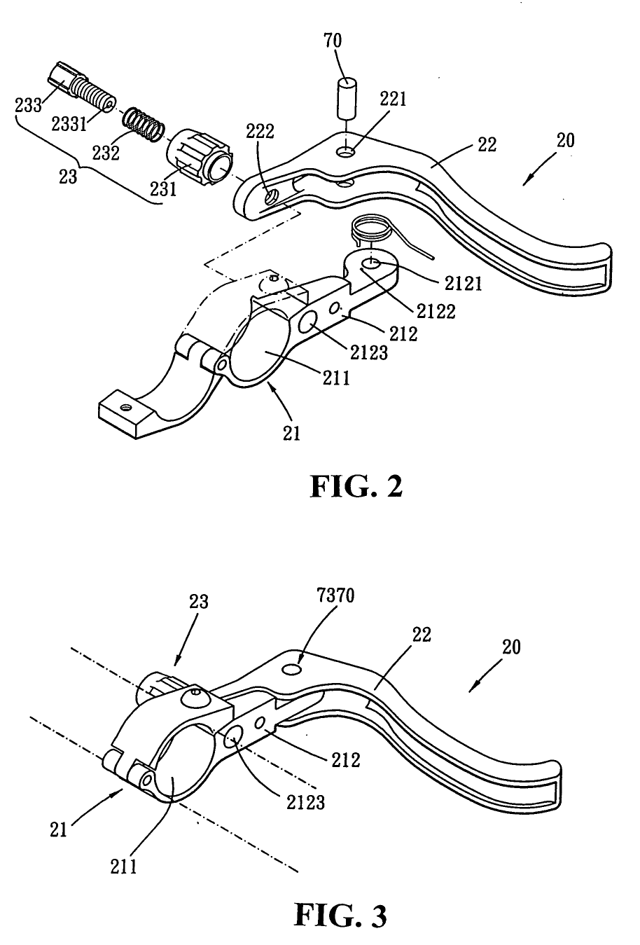

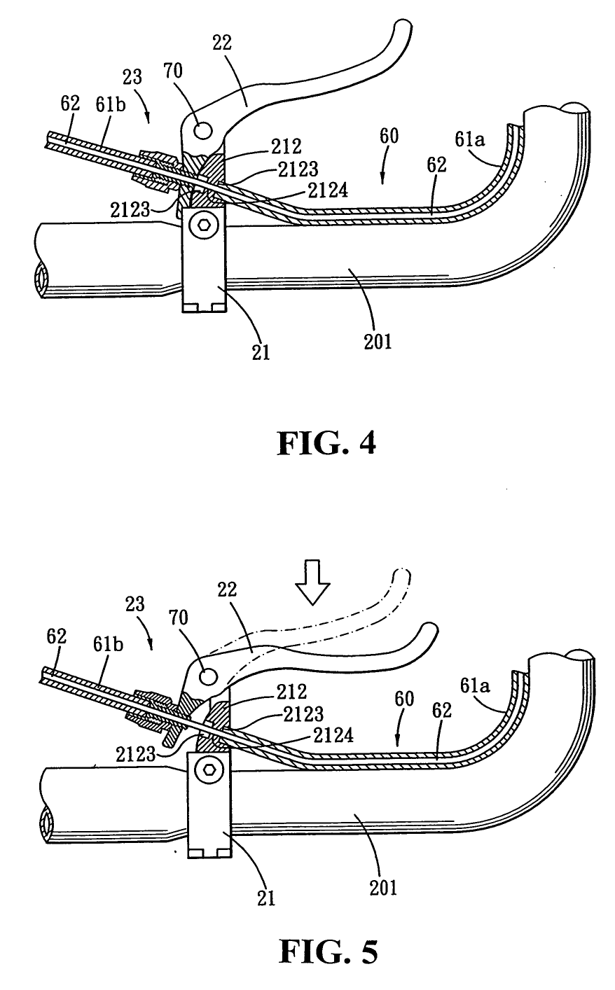

Please refer to FIGS. 2 and 3. The auxiliary handbrake operating device 20 mainly contains a positioning seat 21 and an operating handle 22. At an end of the positioning seat 21, a semi-circular section of the positioning seat 21 is closed by another semi-circular piece hinged to the semi-circular section to form a through hole 211. With the movable semi-circular piece, the positioning seat 21 could be locked to any location along the handle bar 2. Opposite to the through hole 211, the positioning seat 21 has a linear joining section 212. At a far end of the joining section 212, there is a pin hole 2121 for pin-joining the operating handle 22. At an appropriate location around the pin hole 2121, there is a small positioning hole 2122 for fixing an end of a return spring 40. The return spring 40 is for automatically restoring the operating handle 22 to its original position after it is gripped. Please also see FIGS. 4 and 5. Near the through hole 211, the joining section 212 has two lateral and corresponding cable holes 2123 connected by a narrow wire hole 2124. The cable holes 2123 and the wire hole 2124 are arranged so that a brake wire 62 could pass through from one side of the joining section 212 to the other side.

The operating handle 22 has an upper surface and a lower surface forming an open space for accommodating a part of the joining section 212 having the pin hole 2121. At a corresponding location to the pin hole 2121, the upper and lower surfaces of the operating handle 22 have a vertical through hole 221 so that a locking pin 70 could pin-join the operating handle 22 to the positioning seat 21 by inserting the locking pin 70 through the vertical through holes 221 and the pin hole 2121. On an end of the operating handle 22, there is a lateral bolt hole 222 at a corresponding location to the cable hole 2123. The bolt hole 222 is for the installation of a brake wire guiding tube 23. The brake wire guiding tube 23 contains a tubular body 231, and a spring 232 and a guiding bolt 233 both placed inside the tubular body 231. The guiding bolt 233 could be screwed into the bolt hole 222 and the brake wire guiding tube 23 is thereby locked to the operating handle 22. Along the axis of the guiding bolt 233, there is a tunnel 2331 allowing the brake wire 62 to pass through.

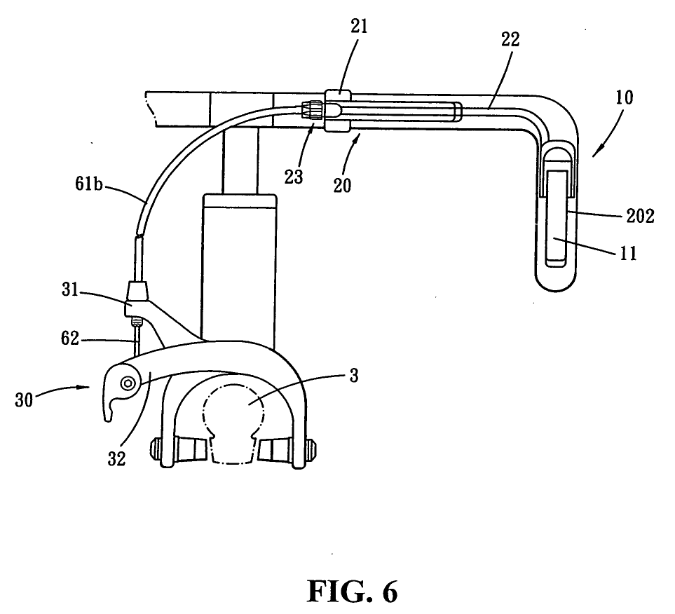

Please refer to FIG. 6. A brake cable 60 containing the brake wire 62 inside is installed as follows. The brake wire 62 has a cylindrical wire head (not shown) and the wire head is fixedly locked to the normal handbrake operating device 10, so that the brake wire 62 would be pulled by the operating handle 11 of the normal handbrake operating device 10. The brake wire 62 is the slid through a cable wrap 61a and both the cable wrap 61a and the brake wire 62 inside extend from the normal handbrake operating device 10 to the auxiliary handbrake operating device 20, along the curved and linear sections 202, 201 of the handle bar 2. The cable wrap 61a is inserted into one of the cable holes 2123 of the joining section 212 while the brake wire 62 is inserted through the wire hole 2124.

After passing through the wire hole 2124, the brake wire 62 continues to pass through the bolt hole 222 and the tunnel 2331 of the guiding bolt 233. The brake wire 62 is then slid through another cable wrap 61a. The cable wrap 61a and the brake wire 62 inside extend toward the handbrake assembly 30 and, finally, the brake wire 62 passes through the first brake arm 31 and connects to the second brake arm 32.

Please note that the most significant feature of the brake cable 60 according to the present invention is that the brake cable 60 is composed of two separate brake wraps 61a and 61b at either side of wire hole 2124 while only the brake wire 62 goes all the way from the normal handbrake operating device 10, through the wire hole 2124 of the auxiliary handbrake operating device 20, and down to the handbrake assembly 30. The cable wrap 61a is positioned between the normal handbrake operating device 10 and one of the cable holes 2123 of the joining section 212. The other cable wrap 61b is positioned between the tubular body 231 of the guiding tube 23 and the first brake arm 31 of the handbrake assembly 30. The brake wire 62 then goes unwrapped from the first brake arm 31 to the second brake arm 32.

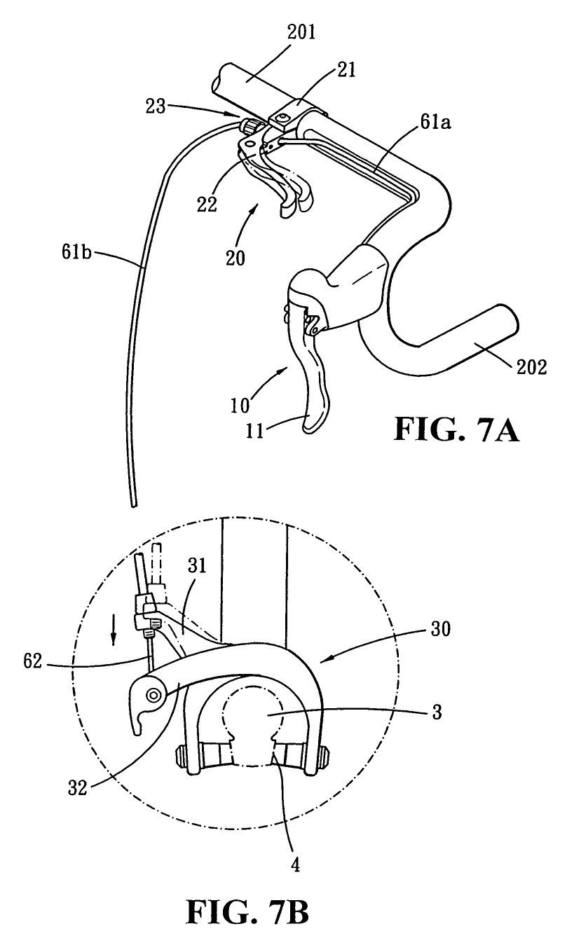

Please refer to FIGS. 7A and 7B and 5. When a rider grips the operating handle 22 of the auxiliary handbrake operating device 20, the operating handle 22 rotates around the locking pin 70 and, in the mean time, pushes the cable wrap 61b toward the handbrake assembly 30. The cable wrap 61b therefore forces the first brake arm 31 to move toward the second brake arm 32 and the bicycle is thereby braked. Please note that, during the process, only the brake wrap 61b is moved and the brake wire 62 is not pushed or pulled at all.

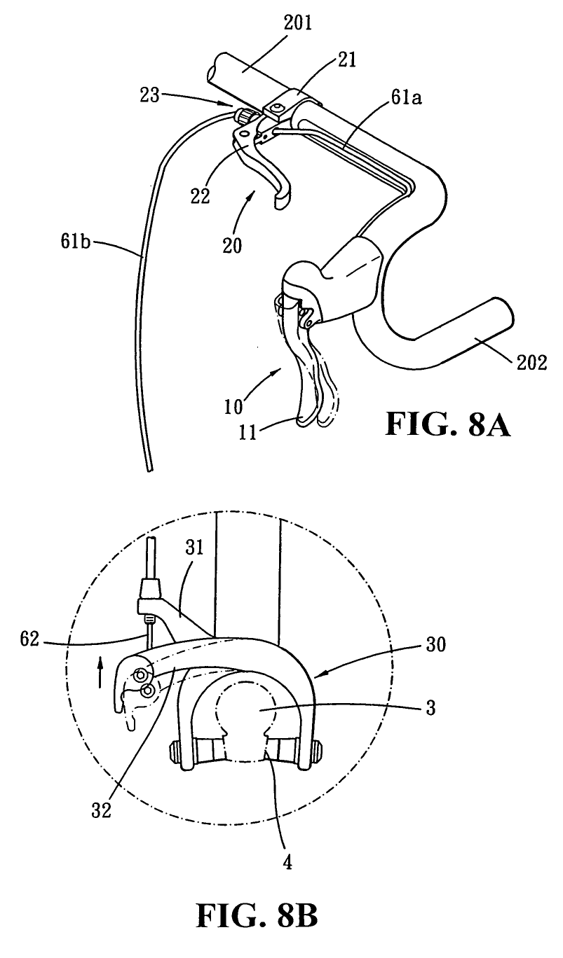

On the contrary, as illustrated in FIGS. 8A and 8B, if the rider grips the operating handle 11 of normal handbrake operating device 10, only the brake wire 62 within the brake wraps 61a and 61b is pulled to force the second brake arm 32 to move toward the first brake arm 31 and the bicycle is thereby braked.

Please note that since the cable wraps 61a and 61b are independent, and the auxiliary and normal handbrake operating devices 20 and 10 use totally separate means for braking the bicycle, the operation of the auxiliary handbrake operating device 20 does not have any influence on the normal handbrake operating device 10, and similarly the operation of the normal handbrake operating device 10 does not impact the auxiliary handbrake operating device 20 as well.

The design of the present invention also makes its implementation quite straightforward. The joining section 212 of the position seat 21 has a similarly simple structure as the conventional ones and the formation of the wire hole 2124 could be achieved by employing a simple and cheap drilling.

The present invention provides auxiliary handbrake operating devices 20 in the middle of the handle bar on a road bike, besides its normal handbrake operating devices 10. This allows a rider to choose appropriate positions and the corresponding handbrake operating devices for his or her hands, based on the road condition. This also provides a higher level of safety to the rider. In addition, the operation of the auxiliary and normal handbrake operating devices does not trigger each other and therefore does not distract the rider.

Please refer to FIGS. 4 and 5 again. Another key factor that prevents the handbrake operating devices from triggering each other lies in that the cable wrap 61a is aligned with the linear section 201 of the handle bar 2 and, then, inserted into one of the cable holes 2123 in a pre-determined angle. The gripping of the operating handle 22 of the auxiliary handbrake operating device 20 therefore wouldn't interfere with the normal handbrake operating device 10. The cable wrap 61a could be bound to the handle bar 2 with adhesive tape or sleeve for comfort or anti-slipping.

The cable holes 2123 are better arranged in such a way that the cable wrap 61a would form an 8°˜15° angle with the linear section 201 of the handle bar 2.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. An auxiliary handbrake operating device, said auxiliary handbrake operating device positioned between a handbrake assembly and a normal handbrake operating device on a handle bar of a bicycle, said auxiliary handbrake operating device allowing a brake wire interconnecting said handbrake assembly and said normal handbrake operating device to pass through, an operating handle of said auxiliary handbrake operating device, when said operating handle is gripped, pushing a cable wrap around said brake wire between said auxiliary handbrake operating device and said handbrake assembly to force said handbrake assembly to brake said bicycle, said auxiliary handbrake operating device comprising:
a positioning seat, said positioning seat comprising a lateral through hole for fitting said handle bar and a linear joining section, said joining section having a vertical pin hole at an end for pin-joining an operating handle, said joining section having lateral cable holes and a wire hole between said vertical pin hole and said lateral through hole so that a brake wire could pass through said joining section; and
an operating handle, said operating handle having a vertical through hole at a corresponding location to said pin hole of said joining section so that a locking pin could pin-join said operating handle to said joining section through said vertical through hole and said pin hole of said joining section, said operating handle having a lateral bolt hole at an end screwed with a guiding tube;
wherein said brake wire has an end fixedly connected to said handbrake assembly and has the other end passed through said guiding tube, said bolt hole, said cable holes, said wire hole, and fixedly connected to said normal handbrake operating device.

2. The auxiliary handbrake operating device according to claim 1, wherein said cable holes are connected by said wire hole having a smaller diameter inside said joining section so that said brake wire could pass directly through said joining section by entering into one of said cable holes, through said wire hole, and out from the other cable hole.

3. The auxiliary handbrake operating device according to claim 1, wherein said joining section has a positioning hole for fixing an end of a return spring; and said return spring is for automatically restoring said operating handle to its original position after it is gripped.

4. The auxiliary handbrake operating device according to claim 1, wherein said guiding tube comprises a guiding bolt, a spring, and a tubular body for accommodating said spring and said guiding bolt.

5. The auxiliary handbrake operating device according to claim 1, wherein said handbrake assembly comprises a first brake arm and a second brake arm hinged together.

6. The auxiliary handbrake operating device according to claim 1, wherein said normal handbrake operating device is installed on a curved section of said handle bar; said auxiliary handbrake operating device is installed on a linear section of said handle bar; said brake wire is wrapped inside a first cable wrap between said normal handbrake operating device's operating handle and one of said cable holes of said joining section of said auxiliary handbrake operating device; said brake wire is wrapped inside a second cable wrap between a first brake arm of said handbrake assembly and said guiding tube screwed to said auxiliary handbrake operating device's operating handle; said first and second cable wraps are separate and independent from each other.

7. The auxiliary handbrake operating device according to claim 4, wherein said guiding bolt has a tunnel along said guiding bolt's axis, allowing said brake wire to pass through; and said guiding bolt has a matching thread for screwing into said bolt hole of said operating handle.

8. The auxiliary handbrake operating device according to claim 5, wherein said brake wire goes through said first brake arm and connects to said second brake arm; the section of said brake wire between said first and second brake arms is unwrapped; and said normal handbrake operating device pulls said second brake arm through said brake wire toward said first brake arm without triggering said auxiliary handbrake operating device.

9. The auxiliary handbrake operating device according to claim 6, wherein said first cable wrap is aligned with said linear section of said handle bar and inserted into one of said cable holes in a pre-determined angle

10. The auxiliary handbrake operating device according to claim 9, wherein said cable holes are configured such that said first cable wrap forms an 8°˜15° angle with said linear section of said handle bar.
